(19) United States
(12) Patent Application Publication
(10) Pub. No.: US 2016/0122114 A1
(43) Pub. Date: May 5, 2016

(54) Insulating Complex and Method for the Production Thereof

(71) Applicant: NOVOSTRAT LIMITED, Limerick. CO (IE)

(72) Inventor: Lionel Maurice Junique, Limerick (IE)

(21) Appl. No.: 14/896,944

(22) PCT Filed: Jun. 13, 2014
(86) PCT No.: PCT/EP2014/062346

§ 371 Date: Dec. 9, 2015

(30) Foreign Application Priority Data
Jun. 13, 2013 (FR) 1355508

(51) Int. Cl. B65D 81/113; B65D 81/38; B26D 3/00

(52) U.S. Cl. CPC B65D 81/113; B26D 3/006; B65D 81/38

(57) ABSTRACT

This insulating complex is made of a block of foam of the PE, PP, PET type having density of between 10 and 150 kg/m³ and has, starting from a plane zone, a series of symmetrical hollow and relief shapes forming alternating and complementary male parts and female parts suitable to allow mating, by superposition, with another complementary complex in such a way as to form a compact solid section and quadrangular assembly.

### CROSS-REFERENCE TO RELATED APPLICATIONS

This U.S. utility patent application is a national stage application under 35 U.S.C. §371 of international application PCT/EP2014/062346, filed Jun. 13, 2014, and claims the benefit of priority under 35 U.S.C. §119 of French Patent Application No. 1355508, filed Jun. 13, 2013, the entire contents of which are hereby incorporated herein by reference for all purposes.

### TECHNOLOGICAL FIELD

The present disclosure concerns an insulating complex and a method for the production thereof, and relates to the technical sector of packaging but does not exclude other application domains, such as sound insulation.

### BACKGROUND

In the prior technical art, to achieve this packaging capability, there is, for instance, a known method of using honeycomb polyurethane foam blocks.

In a well-known art, the polyurethane has open cells so that the resulting product is not rigid, and accordingly, will not take a load. In other words, this type of product is generally used for producing, for instance, small packaging boxes, but is most often used for making mattresses.

To overcome these drawbacks and produce a packaging which will take a load, some have proposed to insert between the two foam blocks, for instance of thin PE, a corrugated structure also made of PE. This solution therefore requires the use of three components which must be assembled using a specific technique. It is a complex and costly technique in which it is important to observe that the foam in the middle, which is heated to be deformed and obtain the corrugation, is necessarily of reduced thickness considering the rigidity of the PE, so that, finally, the resulting product does not take the load properly.

It has also been proposed to produce a packaging product directly from a block or piece of PE foam of a sufficient thickness, for instance, included between 40 and 60 mm, to take the load. This solution demands a large amount of material, significantly increasing the costs.

### SUMMARY OF THE DISCLOSURE

The goal of the presently described embodiments is to remedy the drawbacks described above in a simple, reliable, efficient and rational way.

The embodiments presently described produce a sufficiently rigid packaging product to take the load, with the objective of sharing out the load uniformly and significantly decreasing the quantity of material to be used but without decreasing the rigidity of the product.

An insulating product has been designed and developed from a block of heat-setting foam comprising a series of hollow and relief shapes alternately forming male parts and female parts complementary to each other, allowing their mating, by superimposition, with another complementary complex to form a compact assembly having a solid section and a quadrangular shape.

The foam can be of polyethylene (PE), polypropylene (PP) or polyester (PET).

Advantageously, according to the characteristics of the presently described embodiments a process for producing this insulation complex comprises:

starting with a block of foam having a quadrangular transversal section with thickness included between 10 and 500 mm,

using a profiled blade to make a cut in the middle part of the thickness of the block to form two parts suitable to produce, after separation, a series of hollow and relief shapes, alternately comprising male and female parts to produce two insulating complexes suitable for mating together.

From these characteristics, it is thus possible from a block of a determined thickness, to obtain two identical and symmetrical detachable products, instead of one, due to the forming of the hollow and relief shapes. Note that the hollow and relief shapes improve the load-bearing capacity and spread out the load.

For implementing the process the blade is moved in line down the length of block which is held stationary or vice versa. Preferably, the blade is heated to a temperature included between approximately 60 and 130° C.

Another technical issue that the presently described embodiments resolve is, but not only, producing an insulating complex which takes the load with the least amount of material but, also, able to shape the complex if necessary in consideration of the relative rigid density of the foam being used.

To do this, the hollow and relief shapes are produced from a flat area whose thickness, at the hollow shapes, is very small compared to the depth of said hollow shapes.

According to another characteristic, the hollow and relief shapes are symmetrical and can have a rounded transversal section, forming a sinusoid, or may have a trapezoidal transversal section, but without necessarily ruling out other geometrical shapes.

Note that the hollow and relief shapes run parallel to one another and to the edge of the block or may be orientated differently with respect to the longitudinal edges of the block. They can be rectilinear or not.

### BRIEF DESCRIPTION OF THE FIGURES

The contemplated embodiments are described in greater detail below by means of the attached illustration figures in which:

FIG. 1 is a transversal sectional view of a block of foam which is cut in its thickness to obtain two symmetrical and identical parts to produce two insulating complexes after the separation of said parts.

FIG. 2 is a view corresponding to FIG. 1 showing the separation of the two parts of the block after the cutting operation.

FIGS. 3 and 4 are views corresponding respectively to FIGS. 1 and 2 of another embodiment resulting from the profile of the cutting blade.

FIG. 5 is a perspective view of the insulating complex.

FIG. 6 is a sectional view of an alternative produced shape of the insulating complex.

### DETAILED DESCRIPTION

The insulating complex, according to the present disclosure, is produced from a block (1) of PE, PP or PET foam. The thickness (E) of block (1) is determined according to the type of packed product and corresponds to the thickness values currently used in the field of packaging using PE foam in particular.

According to the presently described embodiments, in the middle part of the thickness of block (1) a cut (2) is made using a profiled blade. The profile of the blade is designed to produce two identical parts (1a) and (1b) capable of creating, after separation, a series of hollow and relief shapes alternately producing male parts (a) and female parts (b).

In other words, from these characteristics, from a single block (1) having a thickness (E), we obtain two identical insulating complexes having approximately equal thickness (E) as indicated below (FIGS. 3 and 4).

According to the method of the presently described embodiments, the blade is moved in line down the length of block (1) which is held stationary without, however, excluding the opposite process, that is, in which block (1) moves with respect to the stationary blade. Note that to make the cut, the blade is heated to a temperature included between approximately 60 and 130° C.

From these characteristics, the insulating complex, produced by this cutting operation, has hollow and relief shapes (a) and (b) made from the plane zone (c). The thickness of plane zone (c) measured at the hollow shapes (b) is very small compared to the depth of said hollow shapes. For instance, if the complex is obtained from a block (1) having a thickness (E) of 60 mm, zone (c) can be approximately 5 mm.

In other words, according to the characteristics underlying the described embodiments based on a block of PE foam 60 mm thick for instance, corresponding to an insulating product according to a prior technical art, we obtain two identical insulating complexes 50 mm thick.

Therefore, two insulating complexes are obtained instead of one, having the same load bearing characteristics, which are, furthermore, improved because of the forming of the hollow and relief zones.

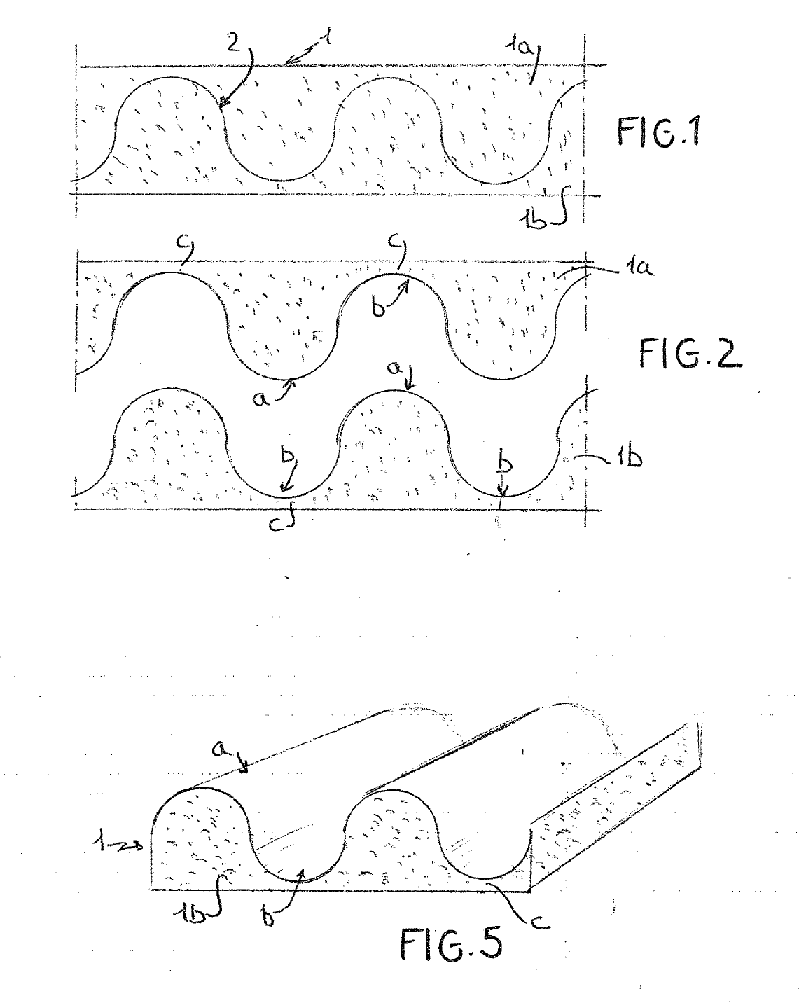

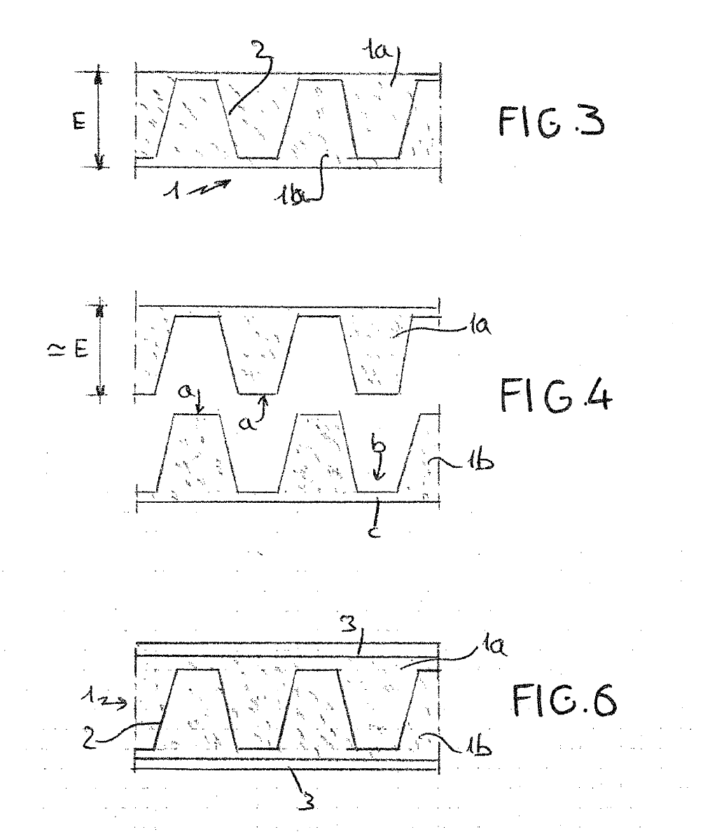

Note that the hollow and relief shapes are symmetrical and can have different transversal section profiles. For instance, in FIGS. 1 and 2, the hollow and relief shapes have a rounded transversal section forming a sinusoid.

In FIGS. 3 and 4, the hollow and relief shapes have a trapezoidal transversal section.

Note that depending on the direction of movement of the blade, the various hollow and relief shapes may run parallel to one another and to the longitudinal edges of the block or may be orientated at an angle with respect to the block. They can be rectilinear or not.

If necessary, to rigidify the product, especially when it has to be bent to match various shapes, it is simply necessary to combine the plane zone of each of the complexes with a rigidity panel (3) which can also be made of PE foam and have a greater density than the density of the PE foam used for producing the complex shape.

As a non-limiting illustration, the density of the block (1), from which the insulating complexes are made, is included between 10 and 150 kg per cubic metre. The block thickness is included between approximately 10 and 500 mm.

In an alternate embodiment, the hollow and relief shapes have arrangements to to ensure their clipping in the mated position.

The advantages are evident from the description.

1. An insulating complex comprising a block of foam of the PE, PP, PET type having density of between 10 and 150 kg/m³ and which includes, starting from a plane zone, a series of symmetrical hollow and relief shapes forming alternating and complementary male parts and female parts, suitable to allow mating, by superposition, with another complementary complex so as to form a compact solid section and quadrangular assembly.

2. The insulating complex according to claim 1, wherein the thickness of plane zone, measured at the hollow shapes, is very small compared to the depth of said hollow shapes.

3. The insulating complex according to claim 1, wherein the hollow and relief shapes have rounded transversal sections forming a sinusoidal shape.

4. The insulating complex according to claim 1, wherein the hollow and relief shapes have trapezoidal transversal sections.

5. The insulating complex according to claim 1, wherein a rigidity panel is combined with the plane zone.

6. The insulating complex according to claim 1, wherein hollow and relief shapes have arrangements to ensure their clipping in the mated position of two superimposed complexes.

7. A process of producing an insulating complex, the process comprising:
starting with a block of foam having a quadrangular transversal section having thickness between 10 and 500 mm,
using a profiled blade to make a cut in the middle part of the thickness of the block to obtain two parts suitable to produce, after separation, a series of hollow and relief shapes, alternately forming male parts and female parts, to obtain two mating insulating complex parts.

8. The process according to claim 7, wherein the blade is moved in line down the length of block which is held stationary or vice versa.
